(19) United States
(12) Patent Application Publication
(10) Pub. No.: US 2015/0195616 A1
(43) Pub. Date: Jul. 9, 2015

(54) SELECTIVE PRESENTATION OF VIDEO ON DEMAND CONTENT SEGMENTS

(71) Applicant: Alcatel-Lucent USA Inc., Murray Hill, NJ (US)

(72) Inventors: Gerardo M. Espinosa, Plano, TX (US); Marcus P. Magri, Frisco, TX (US); Sanjay S. Sharma, Plano, TX (US)

(73) Assignee: Alcatel-Lucent USA Inc., Murray Hill, NJ (US)

(21) Appl. No.: 14/147,100

(22) Filed: Jan. 3, 2014

(51) Int. Cl. H04N 21/454; H04N 21/2668; H04N 21/4545; H04N 21/8543; H04N 21/235; H04N 21/845; H04N 21/81; H04N 7/173; H04N 21/472; H04N 21/61; H04N 21/462; H04N 21/643; H04N 21/234; H04N 21/44

(52) U.S. Cl. CPC H04N 21/4542; H04N 21/23418; H04N 21/2668; H04N 21/45457; H04N 21/8543; H04N 21/2353; H04N 21/44008; H04N 21/8133; H04N 7/17336; H04N 21/47202; H04N 21/6125; H04N 21/4622; H04N 21/6175; H04N 21/64322; H04N 21/8456

(57) ABSTRACT

Systems and methods are disclosed that temporarily suspend the presentation of VOD content that has been indicated as objectionable to a user. One embodiment is a client device that receives a Video On Demand (VOD) datastream, and identifies a time period within the VOD datastream that includes content indicated as objectionable to a user. The client device temporally suspends presentation of the VOD datastream to the user during the time period.

### FIELD OF THE INVENTION

The invention is related to the field of video on demand services.

### BACKGROUND

Video On Demand (VOD) services allow end users to select and watch content on demand. One example of VOD content is a movie. VOD may be distributed by cable providers, distributed using Internet Protocol Television (IPTV) services, and/or distributed using Over The Top (OTT) services. IPTV is a service through which television and other video content is delivered to an end user over a packet-switched network, such as the Internet. OTT services refers to the delivery of video and audio over the Internet without a Multiple-System Operator (MSO) being involved in the control or distribution of the content. A MSO is an operator of multiple cable or direct-broadcast satellite television systems.

Generally, movies are rated to allow the end user to determine if the movie is appropriate for an audience. Thus, when an end user is selecting a specific movie to view via a VOD service, the end user is aware that the movie may not be appropriate for all audiences. For example, an R-rated movie may not be appropriate for young children. However, some end users may not purchase the content even though the content may include only a few seconds of objectionable material, such as nudity or violence. This reduces the revenue for VOD providers and reduces the end user acceptance of VOD services.

### SUMMARY

Embodiments described herein temporarily suspend the presentation of VOD content that has been indicated as objectionable to a user, which allows the user more choices over the VOD content that may be purchased. For example, a user may set up preferences on a client device (e.g., tablet, set top box, phone, etc.) to indicate that violence is objectionable, and then purchase an R-rated movie. During the presentation of the movie, the client device may then temporarily suspend the presentation of the movie (e.g., by blanking the screen, by suppressing the audio, etc.) during scenes of violence, which effectively removes the objectionable material from being presented to the user.

One embodiment is a client device that is configured to receive a VOD datastream. The client device is configured to identify a time period within the VOD datastream that includes content indicated as objectionable to a user, and to temporarily suspend the presentation of the VOD datastream to the user during the time period.

In one embodiment, the client device is further configured to identify metadata associated with the VOD datastream, and to identify the time period within the VOD datastream based on the metadata.

In one embodiment, the metadata is in Extensible Markup Language (XML), and the client device is further configured to identify the time period within the VOD datastream based on XML tags in the metadata that define a type of content depicted by the VOD datastream during the time period.

Another embodiment comprises a non-transitory computer readable medium embodying programmed instruction which, when executed by a processor of a client device, direct the processor to receive a VOD datastream, and to identify a time period within the VOD datastream that includes content indicated as objectionable to the user. The instructions further direct the processor to temporarily suspend presentation of the VOD datastream to the user during the time period.

In one embodiment, the instructions further direct the processor to identify metadata associated with the VOD datastream, and to identify the time period within the VOD datastream based on the metadata.

Another embodiment comprises a VOD server. The VOD server is configured to receive Extensible Markup Language (XML) metadata describing a VOD datastream, and to insert an XML tag that identifies a type of content depicted by the VOD datastream and a time period during which the VOD datastream depicts the type of content into the XML metadata to generate modified XML metadata. The VOD server is further configured to provide the VOD datastream to a client device, and to provide the modified XML metadata to the client device to allow the client device to temporarily suspend presentation of the VOD datastream during the time period.

Other exemplary embodiments may be described below.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication network for providing VOD services in an exemplary embodiment.

FIG. 2 is a flow chart illustrating a method of temporarily suspending the presentation of VOD content that has been indicated as objectionable to a user in an exemplary embodiment.

FIG. 3 illustrates a VOD datastream in an exemplary embodiment.

FIG. 4 is an illustration of a VOD streaming topology in an exemplary embodiment.

FIGS. 5-6 are representations of a metadata.xml file in an exemplary embodiment.

FIG. 7 illustrates a processing system operable to execute a computer readable medium embodying programmed instructions to perform desired functions in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

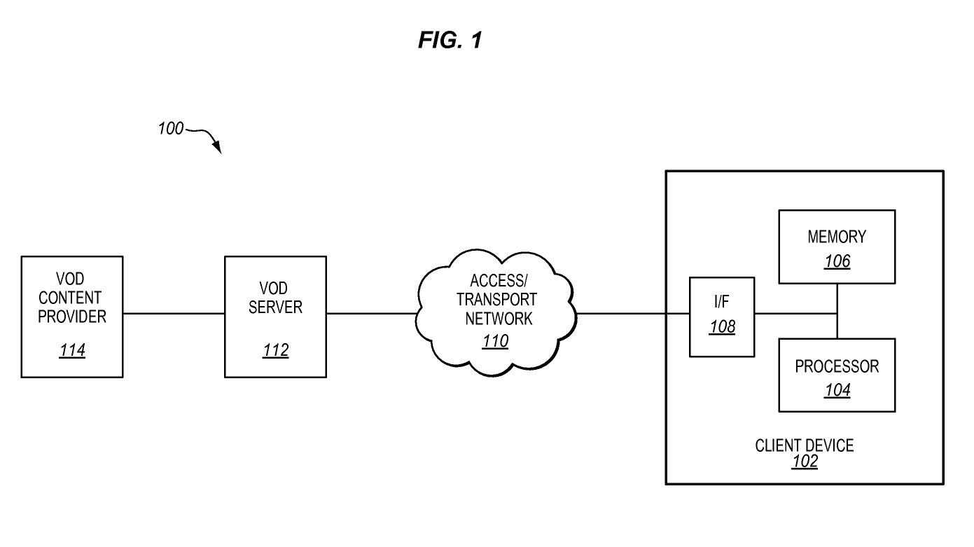

FIG. 1 illustrates a communication network 100 for providing VOD services in an exemplary embodiment. In this embodiment, network 100 includes client device 102, which communicates with a VOD server 112 via an access/transport network 110 to receive VOD content from VOD server 112. VOD server 112 may receive VOD content from VOD content provider 114. In this embodiment, client device 102 includes any component or device that is capable of temporarily suspending the presentation of VOD content that has been indicated as objectionable to a user. The user may be an end-user that is purchasing and/or viewing the VOD content. The VOD content in this embodiment may be distributed via VOD content provider 114 by cable providers, distributed using Internet Protocol Television (IPTV) services, and/or distributed using Over The Top (OTT) services. Some examples of client device 102 include a phone, a tablet, a set top box, etc. Client device 102 may include one or more processors 104 (e.g., Cortex-A9, Intel Atom, etc.) that perform the functionality described herein by executing instructions. Client device 102 may also include memory 106 (e.g., Flash, Static Random Access Memory, etc.), which may store instructions for processor 104, may buffer VOD content, may store metadata information related to the VOD content, etc. Client device 102 may also include an interface (I/F) 108, which allows client device 102 to communicate with access/transport network 110. I/F 108 may be a radio interface (e.g., Wi-Fi, Bluetooth, Cellular, etc.), may be a wired interface (e.g., Ethernet), and/or may be an interface to an IPTV network (e.g., if client device 102 is a set top box configured to interface with an MSO). Access/transport network 110 may include the Internet, a Local Area Network, etc.

Assume for the following embodiment that a user wishes to receive VOD content utilizing client device 102. One problem described previously is that some VOD content may not be selected by a user in cases where various portions of the VOD content are objected to or unsuitable for some audiences. For example, if the user is considering purchasing an R-rated movie, the user may first have to consider if other viewers may object to portions of the movie, regardless of how short or brief the portions may be. If, for instance, other viewers may also be watching the VOD content, then this may be a factor in the user of client device 102 deciding whether or not to purchase the content. In some cases, the user may simply choose different content, which reduces the usefulness of VOD to the user and/or the revenue that may be generated by providing some types of VOD content to the user. Utilizing client device 102, the user may select various preferences regarding which content is objected to and/or how content should be filtered by client device 102. For instance, the user may enter information regarding whether client device 102 is to filter VOD content based on violence, nudity, language, drug use, etc.

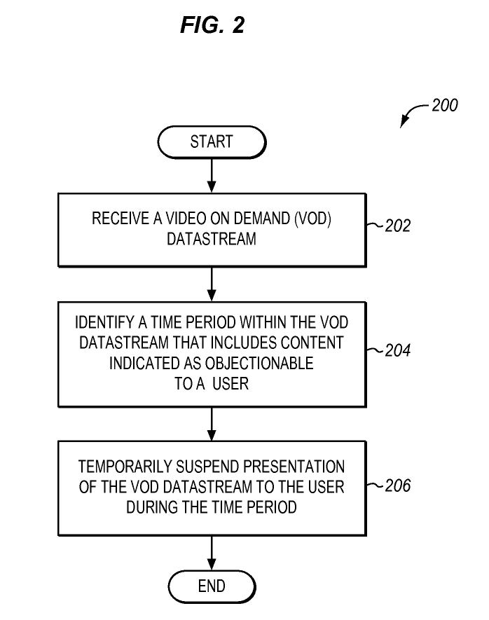

FIG. 2 is a flow chart illustrating a method 200 of temporarily suspending the presentation of VOD content that has been indicated as objectionable to a user in an exemplary embodiment. The steps of method 200 will be described with reference to network 100 illustrated in FIG. 1, but those skilled in the art will appreciate that method 200 may be performed in other systems. Also, the steps of the flow charts described herein are not all inclusive and may include other steps not shown, and the steps may be performed in an alternative order.

The user of client device 102 may browse the available VOD content (e.g., stored by VOD server 112) and select and/or purchase a movie for playback using client device 102. Assume for this embodiment that the VOD content is an R-rated movie. During playback, I/F 108 of client device 102 receives a VOD datastream from VOD server 112 utilizing access/transport network 110 (see step 202 of FIG. 2). Because the movie is on-demand, memory 106 may buffer portions of the movie to account for any communication and/or latency issues that may arise during streaming of the movie to client device 102.

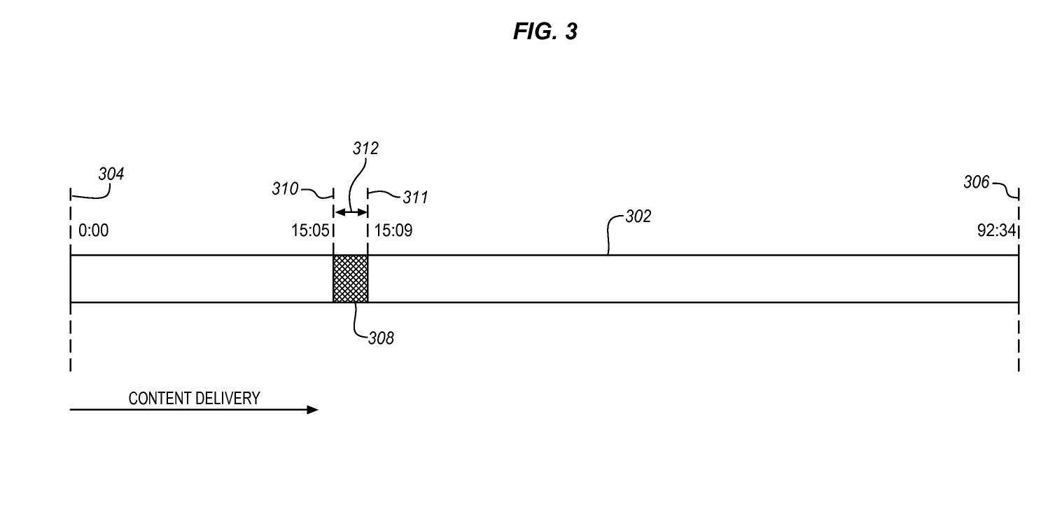

FIG. 3 illustrates a VOD datastream 302 in an exemplary embodiment. In this embodiment, datastream 302 represents the R-rated movie selected by the user for playback using client device 102. Datastream 302 has a start time 304 (i.e., 0:00) and an end time 306 (e.g., ninety two minutes and thirty four seconds (92:34)). During playback, datastream 302 is provided to client device 102 in the direction indicated by the arrow in FIG. 3. Datastream 302 in this embodiment includes objected content 308 which has been indicated by the user as objectionable. Content 308 may be nudity, may be violence, may be language, may be drug use, etc. In FIG. 3, content 308 exists across a portion of datastream 302 that begins at a content start time 310 (e.g., 15:05) and ends at a content end time 311 (e.g., 15:09).

In prior VOD systems, a user faced with VOD content which included objectionable material may elect to bypass purchasing such content. However, client device 102 has been enhanced in this embodiment in order to allow processor 104 to identify time periods within datastream 302 that include content (e.g., content 308 having a time period 312 between content start time 310 and content end time 311) which has been indicated as objectionable to a user of client device 102 (see step 204 of FIG. 2). Time period 312 may be identified by processor 104 in a number of different ways as a matter of design choice. Processor 104 may process datastream 302 (e.g., in real-time or near real-time) to identify content 308, may process metadata associated with datastream 302 to identify tags or markers that identify types of content within datastream 302, may query a database regarding time stamps or other indicia regarding the content of datastream 302, etc. In some cases, content providers generate Extensible Markup Language (XML) metadata for datastream 302 that includes information regarding ownership, title information, actor information, length, rating, etc. One example of such a XML metadata specification for VOD content is described in “Video-On-Demand Content Specification Version 2.0”, released Jan. 5, 2007 by Cable Television Laboratories, Inc. Although this specification generally includes rating information for the content (e.g., R, PG, PG-13, G, etc.), the specification does not include specific XML tags that describe or define sub-content categories (e.g., nudity, violence, language, drug use, etc.) within the VOD content.

In response to processor 104 identifying time period 312 in datastream 302, processor 104 temporarily suspends the presentation of datastream 302 to the user at the appropriate time (see step 206 of FIG. 2). For datastream 302 illustrated in FIG. 3, this occurs during playback of the time period 312 which begins at 15:05 and ends at 15:09. Because client device 102 receives datastream 302 in real-time or near-real time, processor 104 does not halt playback of datastream 302 but instead temporarily replaces or inserts presentation material during playback of datastream 302. This may include blank screens, muted audio, logos, advertisements, etc., as a matter of design choice. For example, if time period 312 includes nudity, then processor 104, at time 15:05 during playback of datastream 302, begins presenting alternate video and/or audio to the user until time period 312 ends at time 15:09. This prevents the user from being exposed to the content indicated by the user as objectionable when viewing datastream 302, thus allowing the user to purchase the VOD content without concern that the content may be unsuitable for some viewers. Client device 102 therefore advantageously allows the user to purchase and enjoy a wider variety of VOD content with the knowledge that brief portions of objectionable material are filtered out during playback of the content by client device 102.

### Example

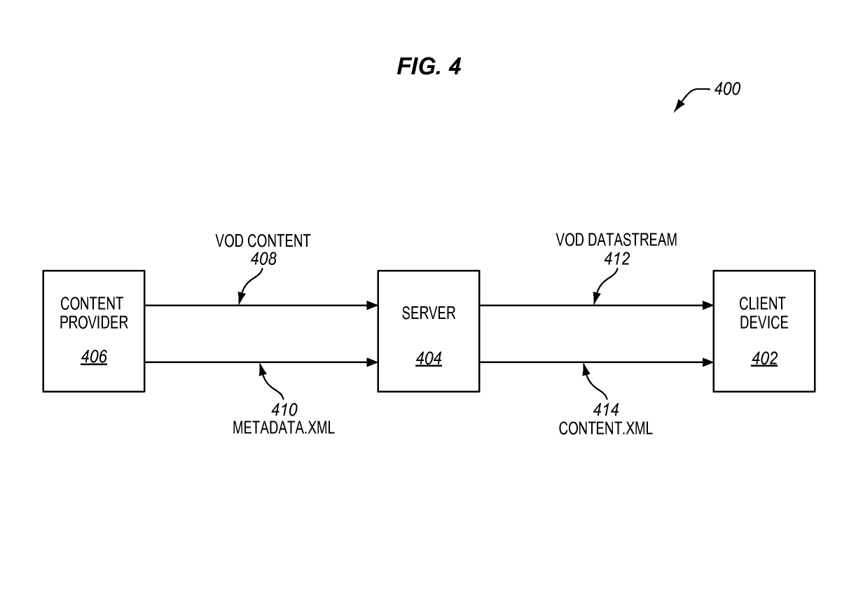

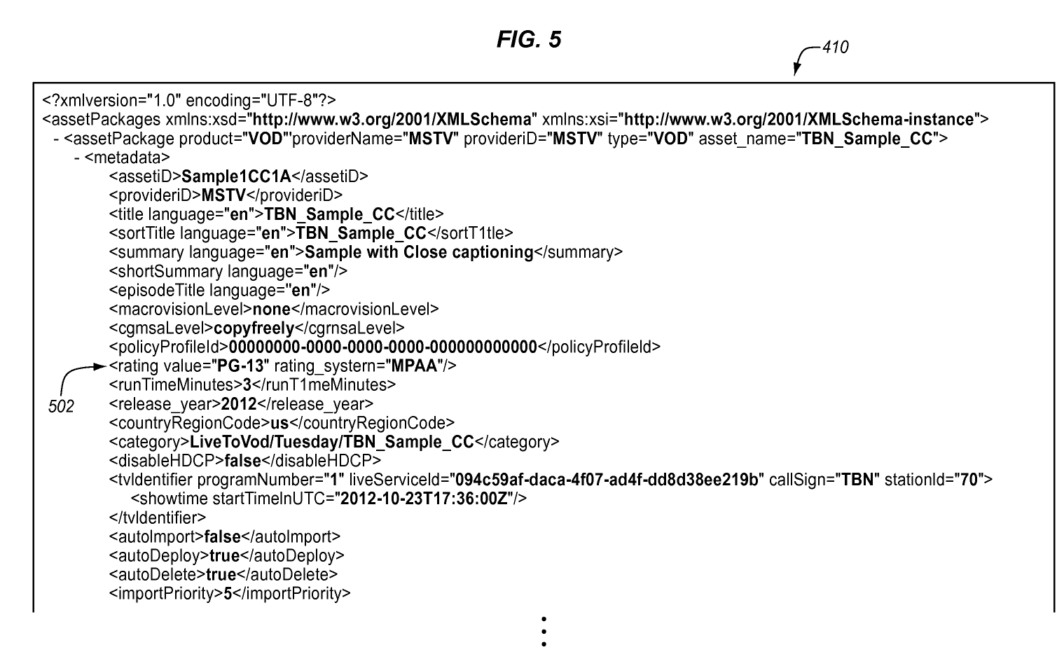

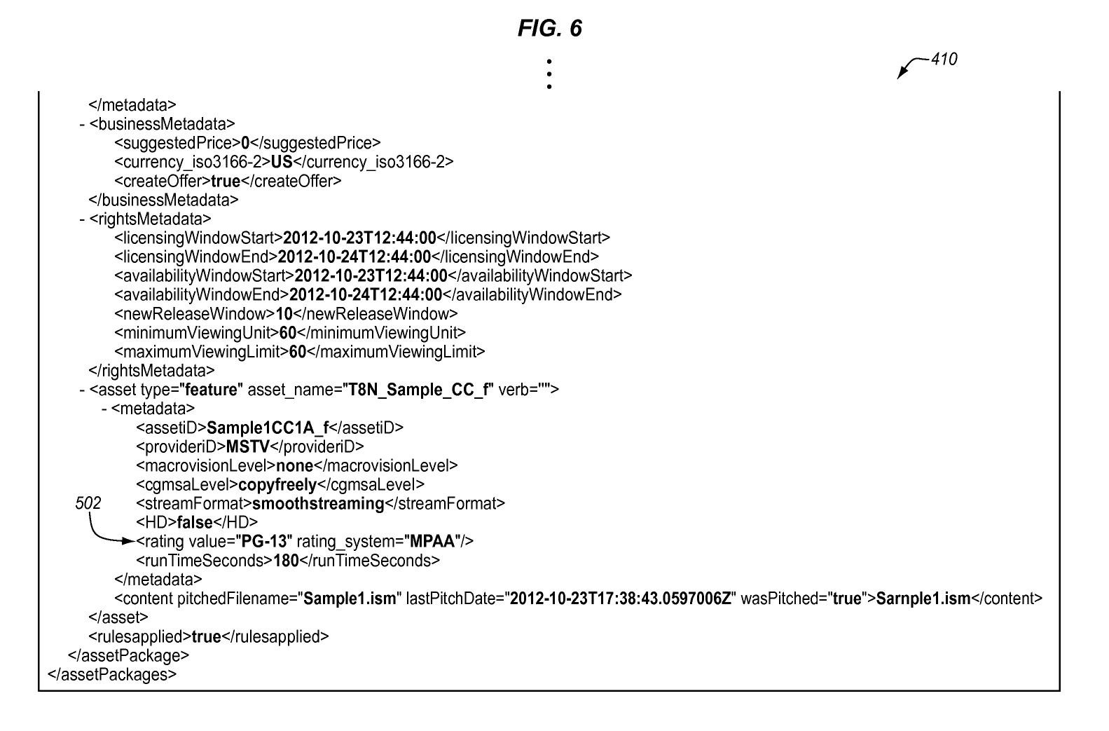

FIG. 4 is an illustration of a VOD streaming topology 400 in an exemplary embodiment. Topology 400 in this embodiment includes a client device 402 (e.g., similar to client device 102 previously described), a VOD server 404, and a content provider 406. Content provider 406 supplies VOD server 404 with VOD content 408, which may be a Motion Picture Experts Group (MPEG) transport stream file for a movie. Content provider 406 also provides VOD server 404 with a metadata.xml file 410 related to the VOD content 408. Metadata.xml 410 may be formatted according to the “Video-On-Demand Content Specification Version 2.0” discussed previously. FIGS. 5-6 are representations of metadata.xml 410 in an exemplary embodiment. Metadata.xml 410 in FIG. 5 includes a tag 502 which specifies the general rating of VOD content 408.

Upon receipt of VOD content 408 and metadata.xml 410, VOD server 404 may insert various XML tags into metadata.xml 410 in order to generate a content.xml file 414 to allow client device 402 to identify content types and time frames within VOD content 408 during playback. For example, VOD server 404 may insert the following tags based on the particular portions of VOD content 408 that include the various content types below:

| | |
|---|---|
| <Nudity> | 15:05-15:09 |
| <Violence-High> | 60:12-62:51 |
| <Violence-Low> | 63:01-63:05 |
| <Language> | 72:00-72:04. |

A user of client device 402, prior to ordering the movie corresponding to VOD content 408, enters preferences using client device 402 regarding what type of content to filter during playback of VOD content 408. For instance, the user may indicate that Language content should be filtered by client device 408 during playback. Upon ordering the movie, VOD server 404 provides VOD datastream 412 to client device 402. VOD datastream 412 may be a re-formatted version of VOD content 408 received by content provider 406. For instance, VOD server 404 may re-process VOD content 408 based on the presentation capabilities of client device 402 (e.g., display resolution, decoding ability, audio ability, etc., of client device 402).

VOD server 404 also provides content.xml 414 to client device 402, which includes the various content type XML tags described above. Responsive to receiving content.xml 414, client device 412 processes content.xml 414 to determine which, if any, time periods correspond to the language filtering option indicated by the user as objectionable. In the example, content.xml 414 includes a <Language> tag identifying a time period within VOD datastream 412 from 72:00 to 72:04. During playback of VOD datastream 412, client device 402 identifies timestamps associated with playback, and determines when 72:00 is reached during the presentation of VOD datastream 412. When 72:00 is reached, client device 402 then temporarily suspends the presentation of VOD datastream 412. Client device 402 may, during the times from 72:00 to 72:04, mute or replace the audio stream for VOD datastream 412. This prevents the user from being presented with the objectionable content within VOD datastream 412 from the time frame 72:00 to 72:02, thereby allowing the user to purchase VOD content 408 without concern for the presentation of brief and possibly objectionable material within VOD content 408.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

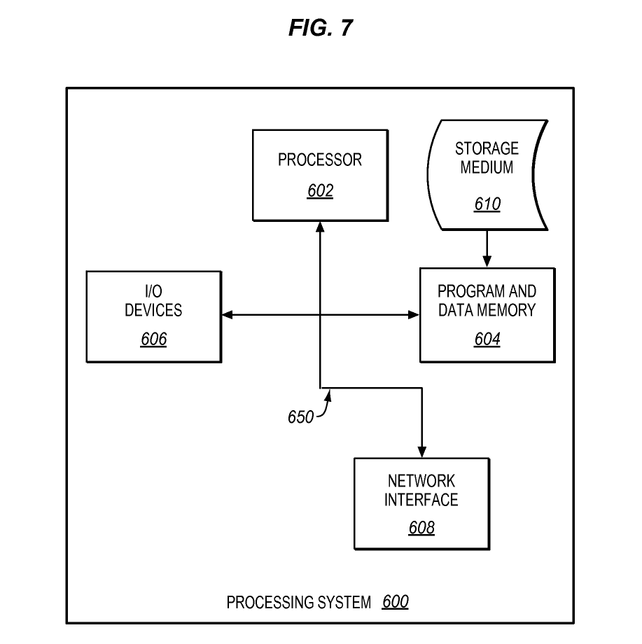

Embodiments disclosed herein can take the form of software, hardware, firmware, or various combinations thereof. In one particular embodiment, software is used to direct a processor for client device 102 (see FIG. 1) to perform the various operations disclosed herein. FIG. 7 illustrates a processing system 600 operable to execute a computer readable medium embodying programmed instructions to perform desired functions in an exemplary embodiment. Processing system 600 is operable to perform the above operations by executing programmed instructions tangibly embodied on computer readable storage medium 610. In this regard, embodiments of the invention can take the form of a computer program accessible via computer-readable medium 610 providing program code for use by a computer or any other instruction execution system. For the purposes of this description, computer readable storage medium 610 can be anything that can contain or store the program for use by the computer.

Computer readable storage medium 610 can be an electronic, magnetic, optical, electromagnetic, infrared, or semiconductor device. Examples of computer readable storage medium 610 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), digital versatile disk (DVD), and Blu-ray.

Processing system 600, being suitable for storing and/or executing the program code, includes at least one processor 602 coupled to program and data memory 604 through a system bus 650. Program and data memory 604 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 606 (including but not limited to keyboards, displays, pointing devices, etc.) can be coupled either directly or through intervening I/O controllers. Network adapter interfaces 608 may also be integrated with the system to enable processing system 600 to become coupled to other data processing systems or storage devices through intervening private or public networks. Modems, cable modems, and Ethernet interfaces are just a few of the currently available types of network interfaces 608.

Although specific embodiments were described herein, the scope of the invention is not limited to those specific embodiments. The scope of the invention is defined by the following claims and any equivalents thereof.

We claim:

1. An apparatus comprising:
a client device configured to receive a Video On Demand (VOD) datastream, to identify a time period within the VOD datastream that includes content indicated as objectionable to a user, and to temporarily suspend presentation of the VOD datastream to the user during the time period.

2. The apparatus of claim 1 wherein:
the client device is further configured to identify metadata associated with the VOD datastream, and to identify the time period within the VOD datastream based on the metadata.

3. The apparatus of claim 2 wherein:
the metadata is in Extensible Markup Language (XML); and
the client device is further configured to identify the time period within the VOD datastream based on XML tags in the metadata that define a type of content depicted by the VOD datastream during the time period.

4. The apparatus of claim 1 wherein:
the content indicated as objectionable to the user is at least one of nudity and violence.

5. The apparatus of claim 1 wherein:
the client device is further configured to display an advertisement to temporarily suspend presentation of the VOD datastream to the user during the time period.

6. The apparatus of claim 1 wherein:
the client device is further configured to display a blank screen to temporarily suspend presentation of the VOD datastream to the user during the time period.

7. The apparatus of claim 1 wherein:
the client device is an Internet-Protocol Television (IP-TV) set-top box.

8. The apparatus of claim 1 wherein:
the client device is an Over The Top (OTT) client.

9. The apparatus of claim 1 wherein:
the client device is further configured to receive content preferences from the user, and to identify the time period within the VOD datastream based on the content preferences.

10. A non-transitory computer readable medium embodying programmed instructions which, when executed by a processor of a client device, direct the processor to:
receive, by the client device, a Video On Demand (VOD) datastream;
identify a time period within the VOD datastream that includes content indicated as objectionable to a user; and
temporarily suspend presentation of the VOD datastream to the user during the time period.

11. The non-transitory medium of claim 10 wherein instructions directing the processor to identify the time period further comprise instructions to:
identify metadata associated with the VOD datastream; and
identify the time period within the VOD datastream based on the metadata.

12. The non-transitory medium of claim 11 wherein:
the metadata is in Extensible Markup Language (XML); and
instructions directing the processor to identify the time period further comprise instructions to:
identify the time period within the VOD datastream based on XML tags in the metadata that define a type of content depicted by the VOD datastream during the time period.

13. The non-transitory medium of claim 10 wherein:
the content indicated as objectionable to the user is at least one of nudity and violence.

14. The non-transitory medium of claim 10 wherein instructions directing the processor to temporarily suspend presentation further comprise instructions to:
display an advertisement during the time period.

15. The non-transitory medium of claim 10 wherein instructions directing the processor to temporarily suspend presentation further comprise instructions to:
display an blank screen during the time period.

16. The non-transitory medium of claim 10 wherein:
the client device is an Internet-Protocol Television (IP-TV) set-top box.

17. The non-transitory medium of claim 10 wherein:
the client device is an Over The Top (OTT) client.

18. The non-transitory computer readable medium of claim 10 wherein:
the instructions further direct the processor to:
receive content preferences from the user; and
instructions directing the processor to identify the time period further comprise instructions to:
identify the time period within the VOD datastream based on the content preferences.

19. An apparatus comprising:
a Video On Demand (VOD) server configured to receive Extensible Markup Language (XML) metadata describing a VOD datastream, and to insert an XML tag that identifies a type of content depicted by the VOD datastream and a time period during which the VOD datastream depicts the type of content into the XML metadata to generate modified XML metadata;
the VOD server further configured to provide the VOD datastream to a client device, and to provide the modified XML metadata to the client device to allow the client device to temporarily suspend presentation of the VOD datastream during the time period.

20. The apparatus of claim 19 wherein:
the XML tag identifies at least one of nudity and violence depicted in the VOD datastream during the time period.
